(19) United States
(12) Patent Application Publication
(10) Pub. No.: US 2017/0252876 A1
(43) Pub. Date: Sep. 7, 2017

(54) METHOD AND APPARATUS FOR LEVITATION ADDITIVE WELDING OF SUPERALLOY COMPONENTS

(71) Applicant: Siemens Energy, Inc., Orlando, FL (US)

(72) Inventor: Gerald J. Bruck, Titusville, FL (US)

(21) Appl. No.: 15/060,892

(22) Filed: Mar. 4, 2016

(51) Int. Cl. B23P 6/00; B23K 9/04; B23K 9/23; B23K 9/095; B23K 26/34; B23K 26/14; B23K 26/70; B23K 26/08; B23K 9/00; B23K 9/32

(52) U.S. Cl. CPC B23P 6/007; B23K 9/0026; B23K 9/04; B23K 9/23; B23K 9/324; B23K 26/34; B23K 26/1464; B23K 26/702; B23K 26/083; B23K 26/0869; B23K 9/0953

(57) ABSTRACT

Superalloy components for turbine engines are additively welded by propelling a stream of powdered filler, which includes superalloy powder filler, through a nozzle at a powder stream mass flow rate, with pressurized gas. The powdered filler stream is melted and agglomerated into a continuous melt stream with a laser or arc heating source located downstream of the nozzle. The melt stream is levitated within a magnetic field generated by at least one electromagnet coil that is oriented downstream of the heating source, and directed onto the superalloy component, by relative motion between the melt stream and the superalloy component.

### TECHNICAL FIELD

The invention relates to additive weld cladding of superalloy metal components of turbine engines, for example, to repair voids or build up surface dimensions of an existing superalloy component, or to manufacture a new part. More particularly, the invention relates to additive weld cladding or repair of voids in superalloy metal components by creating a continuous weld melt stream from agglomerated powder filler with a heat source, such as a laser or arc generator, and levitating the weld melt stream with an electromagnet coil, so that the weld stream is applied to the superalloy component.

### BACKGROUND

Components of combustion turbine engines, such as blades or vanes, are often cast with nickel-, iron-, or cobalt-based superalloy materials. Many superalloy materials are negatively impacted by conventional welding processes, including arc welding and energy beam welding processes. Such processes direct energy toward filler metal and the component substrate, inevitably delivering more heat than the minimum required to melt filler material and fuse it to the substrate. Excess heat application causes one or more of molten metal superheating, substrate over melting, solidification cracking, physical distortion, and retained residual stresses within the material. The retained residual stresses often cause additional cracking during post weld heat treatment cycles.

### SUMMARY OF INVENTION

Exemplary embodiments described herein additively weld superalloy components for turbine engines. In some embodiments, the weld material repairs a surface void in the component. In other embodiments, the superalloy component is clad with a weld layer, in order to increase its surface dimensions, or to manufacture a completely new component. In accordance with embodiments described herein, welding is performed by propelling a stream of powdered filler, which includes superalloy powder filler, through a nozzle at a powder stream mass flow rate, with pressurized gas. The powdered filler stream is melted and agglomerated into a continuous melt stream with a laser or arc heating source located downstream of the nozzle. Melt stream temperature is maintained 10 to 50 degrees Celsius above the component material's melting point, which provides sufficient superheat to enable fusion at the component weld site. The melt stream is levitated, within a magnetic field generated by at least one electromagnet coil that is oriented downstream of the heating source. The magnetic levitation facilitates a more precise orientation of the weld cladding layer at the component weld site, by counteracting gravitational forces imparted on the melt stream. In some embodiments, the levitated melt stream is enveloped within inert or partially inert gas, to protect it from atmospheric reaction, and is directed onto the superalloy component, by relative motion between the melt stream and the superalloy component. The welding system and welding method embodiments described herein facilitate application of minimal heat to the weld filler and the weld site of the component substrate that is necessary to achieve desired filler to substrate fusion, while avoiding excessive heat application that leads to post weld component cracking or other of the aforementioned excess heat application disadvantages.

Exemplary embodiments of the invention feature a method for additive weld repair of a void in a repair site of a superalloy component. The method is performed by providing a superalloy component, having a repair site, which includes a void having an initial void depth. A stream of powdered filler, which includes superalloy powder filler, is propelled through a nozzle at a powder stream mass flow rate, with pressurized gas. The powdered filler stream is melted and agglomerated into a continuous melt stream, having a melt stream velocity and flow rate, with a laser or arc heating source downstream of the nozzle. Melt stream temperature is maintained 10 to 50 degrees Celsius above the component material's melting point, which provides sufficient superheat to enable fusion at the component repair site. The melt stream is levitated within a magnetic field generated by at least one electromagnet coil that is oriented downstream of the laser or arc heating source. In some embodiments, the melt stream is enveloped within inert or partially inert gas, to protect it from atmospheric reaction, and is directed into the repair site void, by relative motion between the melt stream and the superalloy component. During the welding, the melt stream creates localized melting of the repair site no deeper than ten percent of initial depth of the void.

Other exemplary embodiments of the invention feature a method for additive weld cladding of a superalloy component, having a cladding site, by propelling a stream of powdered filler, which includes superalloy powder filler, through a nozzle at a powder stream mass flow rate, with pressurized gas. The powdered filler is melted and agglomerated into a continuous melt stream, having a melt stream velocity and flow rate, with a laser or arc heating source downstream of the nozzle. During the melting and agglomeration, temperature of the melt stream is maintained 10 to 50 degrees Celsius above the component material's melting point, which provides sufficient superheat to enable fusion at the component cladding site. The melt stream is levitated within a magnetic field generated by an electromagnet coil. In some embodiments, the melt stream is enveloped within inert or partially inert gas, to protect it from atmospheric reaction, and is directed onto the cladding site, by relative motion between the melt stream and the superalloy component. The melt stream creates localized melting of the cladding site no deeper than ten percent of component thickness at the weld site.

Additional exemplary embodiments of the invention feature a superalloy component additive welding system, which includes a workpiece table, for holding a superalloy component that has a cladding site and a welding head. The welding head has a pressurized gas source, a hopper, containing powdered filler that includes superalloy powder filler, and a powder feed in communication with the hopper. The powder feed includes a powder feed outlet. The welding head includes a nozzle, having an upstream portion in communication with the pressurized gas source and the powder feed outlet, for propelling the powdered filler there through the nozzle at a powder stream mass flow rate. A laser or arc heating source is located in the welding head downstream of the nozzle, for melting and agglomerating the powdered filler stream into a continuous melt stream having a melt stream velocity and flow rate. Melt stream temperature is maintained 10 to 50 degrees Celsius above the substrate material's melting point, which provides sufficient superheat to enable fusion at the component cladding site. In some embodiments, the melt stream is enveloped within inert or partially inert gas, to protect it from atmospheric reaction. At least one electromagnet coil is oriented downstream of the laser or arc heating source, for levitating the melt stream with a magnetic field. In some embodiments, there is an array of electromagnet coils. A controller is coupled to the laser or arc heating source and the at least one electromagnet coil, for selectively regulating any one or more of melt stream agglomeration, velocity, flow rate, and levitation position relative to the cladding site, so that melt stream temperature is maintained with sufficient superheat (e.g., the aforementioned 10 to 50 degrees Celsius above melting point of the component material) to enable fusion at the component cladding site, with localized melting of the cladding site no deeper than ten percent of component thickness at the cladding site.

The respective features of the exemplary embodiments of the invention that are described herein may be applied jointly or severally in any combination or sub-combination.

### BRIEF DESCRIPTION OF DRAWINGS

The exemplary embodiments of the invention are further described in the following detailed description in conjunction with the accompanying drawings, in which:

FIG. 1 is a schematic view of a superalloy component additive welding system, constructed in accordance with an embodiment of the invention;

FIG. 2 is a schematic view of a welding head and controller of the system of FIG. 1;

FIG. 3 is an elevational schematic of the welding system of FIGS. 1 and 2, showing transformation of the weld powder particles ejected as a powder stream from the nozzle, by application of gas pressure P, with the powder stream agglomerating from molten particles into a continuous flow of melt by exposure to laser energy E, and levitation of the continuous melt stream by a magnetic field B, generated by an electromagnet array, the melt stream then applied to a void repair or cladding build-up site on the superalloy component; and

FIG. 4 is an elevational schematic, similar to FIG. 3, of an alternate embodiment of the welding system of FIGS. 1 and 2, wherein the heat source for agglomeration of the weld powder particles is an arc current source, rather than a laser.

To facilitate understanding, identical reference numerals have been used, where possible, to designate identical elements that are common to the figures.

### DESCRIPTION OF EMBODIMENTS

Exemplary embodiments of the invention are utilized in additive welding systems for superalloy components for turbine engines. In some embodiments, the added weld material repairs a surface void in the component, so that original component dimensional specifications are restored. In other embodiments, the superalloy component is clad with a weld layer, in order to increase its surface dimensions. In accordance with embodiments described herein, welding is performed by propelling a stream of powdered filler, which includes superalloy powder filler, through a nozzle at a powder stream mass flow rate, with pressurized gas. The powdered filler stream is melted and agglomerated into a continuous melt stream with a laser or arc heating source located downstream of the nozzle. In some embodiments, the pressurized propulsion gas or auxiliary downstream gas is inert, or partially inert, to shield heated and melted powder from atmospheric reaction; especially oxidation. The melt stream is levitated, within a magnetic field generated by at least one electromagnet coil that is oriented downstream of the heating source. The melt stream is directed onto the superalloy component, by relative motion between the melt stream and the superalloy component. Shielding inert, or partially inert, gas also blankets the area of melt stream impact and fusion with the superalloy component.

In embodiments described herein, one or more of the powder stream mass flow rate, particle melt agglomeration rate and melt stream mass flow rate are selectively controlled and regulated, so that the melt stream temperature is maintained with sufficient superheat (e.g. 10 to 50 degrees Celsius above the component material's melting point) to enable fusion at the existing superalloy component, and so that localized melting of the repair or cladding site is no deeper than 10 percent of the void depth or component thickness at the weld site. Minimizing the melt stream temperature and localized melting of the component at the weld site, reduces likelihood of solidification cracking of the component during processing and post-weld cooling, or reheat cracking of the component during post weld heat treatment. In embodiments of the welding system described herein, equipment control parameters for controlling melt stream temperature and localized component melting include weld filler powder composition, weld powder feed rate (“F”), gas pressure and flow rate (“P”) applied to the nozzle, heat source energy (“E”) imparted on the filler powder particles by the heat source (e.g., laser or electric arc generator), levitation magnetic field (“B”) strength and orientation, and relative motion between the melt stream and the additive weld site (repair or build-up) on the component.

### Welding System Architecture

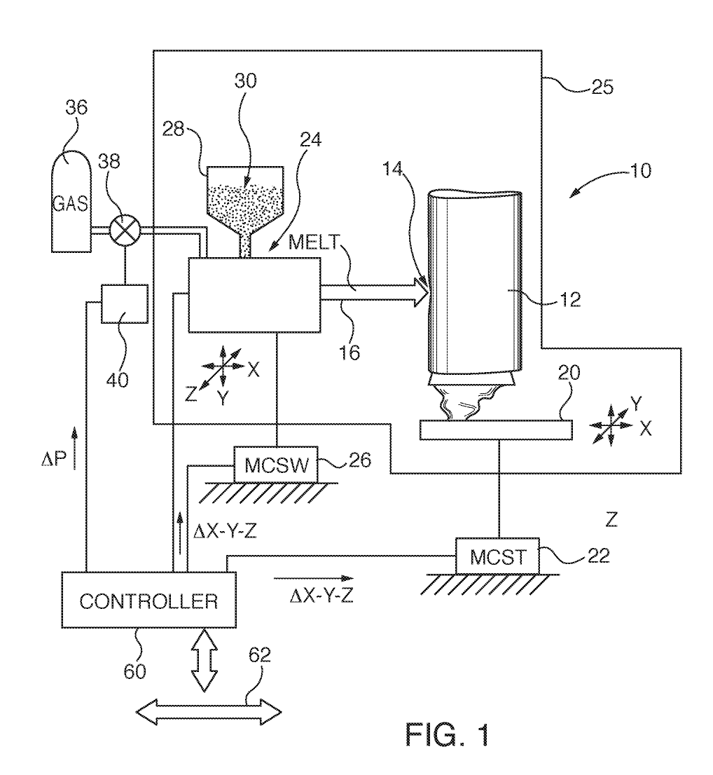

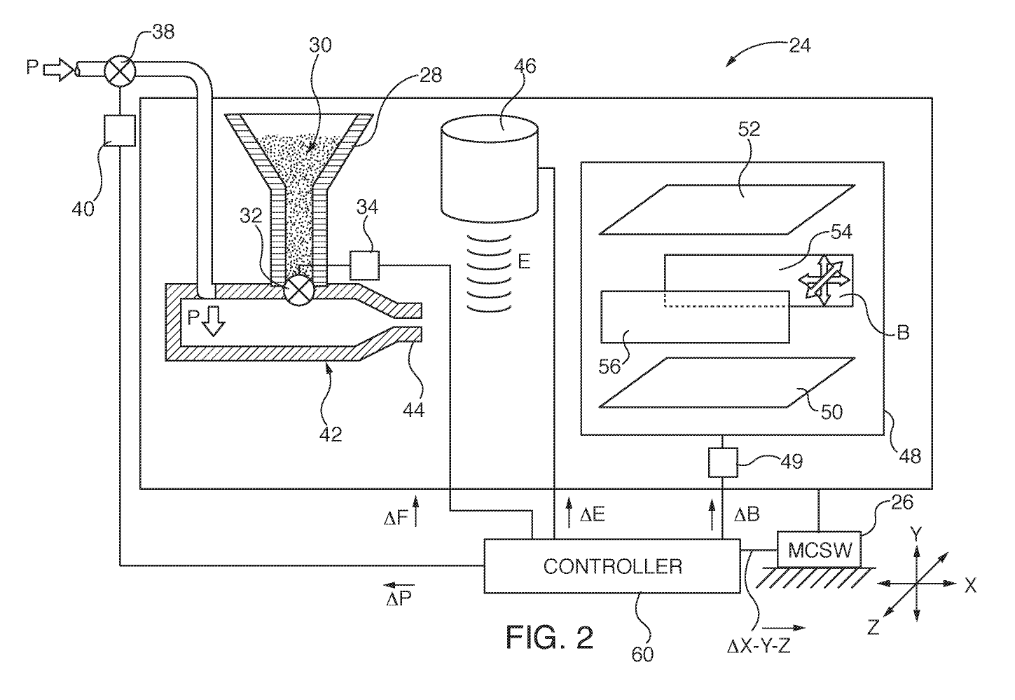

FIGS. 1 and 2 show an exemplary embodiment of an additive welding system apparatus 10 of the invention, for application of a weld cladding layer to a superalloy component for a turbine engine. Exemplary turbine engine component alloys include CM247, Rene 80, CMSX4, IN738, IN939, IN617, IN718, IN625, X-750, and various Haynes alloys such as X, W, 25, 120, NS163, 188, 214, 230, 242, 263, 282 and 556.

Here, a turbine blade 12, formed from a superalloy metal alloy, has a void or depression 14, which is filled with a continuous flowing, weld melt stream 16. The blade 12 is affixed to a workpiece table 20, which is selectively movable in X, Y, and Z coordinate axes by motion control system that is coupled to the table (“MCST”) 22. The welding system 10 has a welding head 24, which is selectively movable in X, Y, and Z coordinate axes by a motion control system that is coupled to the welding head (“MCSW”) 26. The MCST 22 and MCSW 26 enable relative motion between the blade superalloy component 12 weld site 14 and the weld stream melt 16. While in FIG. 1, both the workpiece table 20 and the welding head 24 are capable of motion relative to each other, in alternative embodiments (not shown); only one of them is movable. In other alternative embodiments, neither the workpiece table 20 nor the welding head 24 is movable; the weld stream is steered by the aforementioned magnetic field B, generated by an electromagnetic core array, analogous to rastering of electrons on a cathode ray tube display. The superalloy component blade 12 and the welding head 24 are in an isolation chamber 25, which is filled with inert or partially inert gas. The isolation chamber 25 envelops and blankets molten metal of the melt stream, as well as the area of melt stream impact and fusion with the superalloy component in the inert or partially inert gas, in order to shield it from atmospheric reaction: particularly from oxidation. As an alternative to a full isolation chamber 25, localized shielding that is often employed in arc welding operations is used to isolate the volume around the melt stream and the weld site molten metal. Some self-fluxing superalloys, such as STELLITE®, do not require atmospheric isolation. For those types of materials, atmospheric isolation is not needed to perform the welding methods described herein.

The welding head 24 includes a welding metallic filler powder hopper 28, which contains filler powder 30. In some embodiments, the powder hopper 28 is preheated to maintain the filler powder in dry condition. The filler powder 30 comprises superalloy powder, which may have powder melt temperature similar to that of the superalloy material that forms the component 12. Exemplary superalloy powders include CM247, Rene 80, IN738 and IN939. Powder feed 32 is interposed at an outlet of the powder hopper 28, and selectively driven by a powder feed drive actuator 34, for controlling powder feed rate F. In some embodiments, the actuator controls the speed of a wheel with slots that capture increments of powder thereby modulating the powder feed rate. A pressurized gas source 36 provides a supply of inert or other gas at gas pressure P. Gas pressure and flow rate are regulated by gas-flow control valve 38, which is actuated by the valve actuator 40. Respective outlets of the gas-flow control valve 38 and the powder feed 32 are in communication with an internal chamber of a powder spray gun 42. The powder spray gun 42 has a nozzle 44.

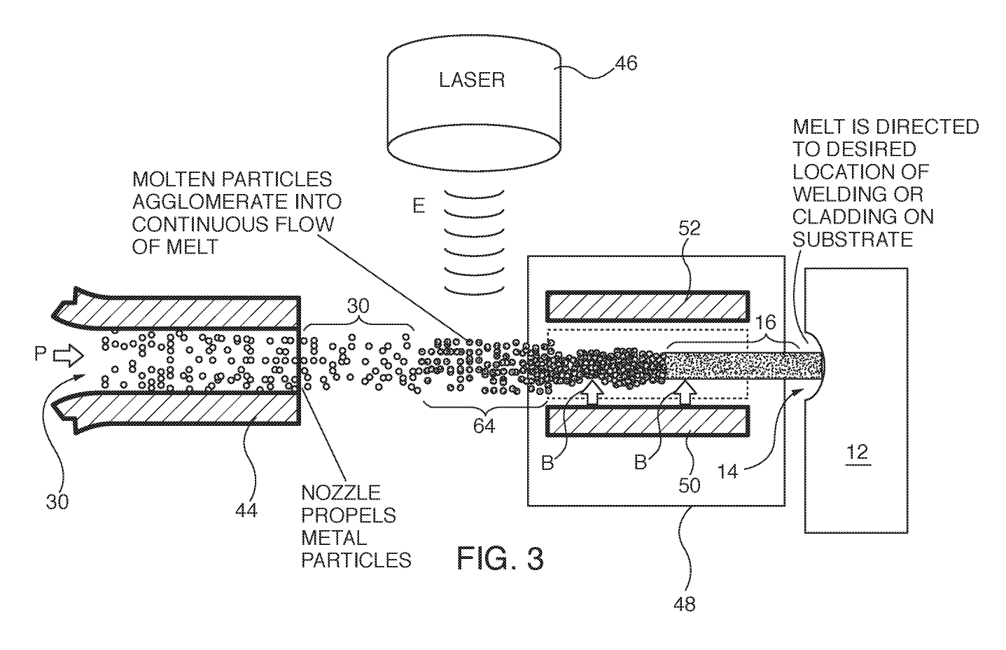

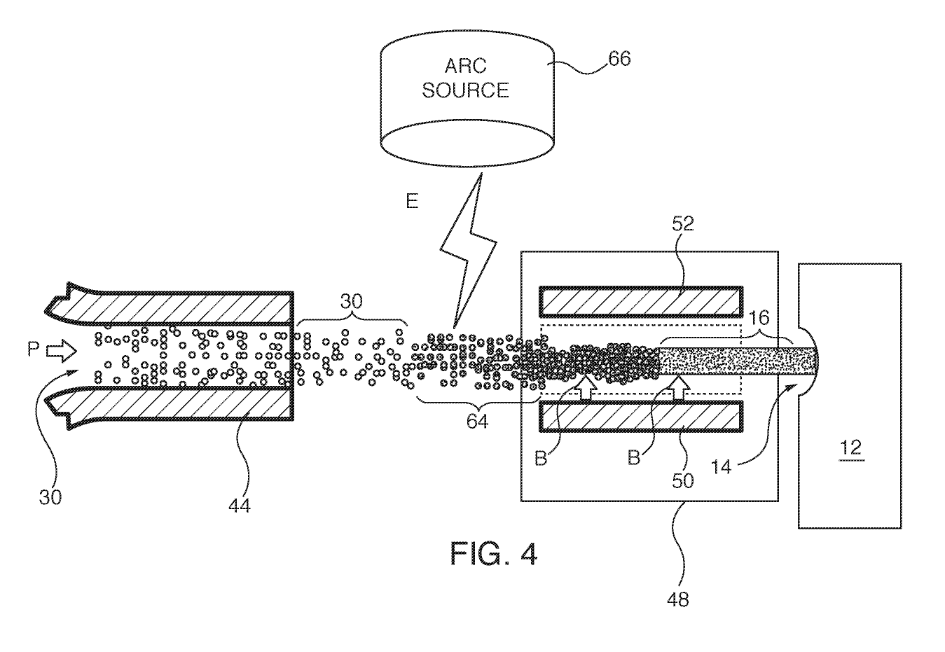

The welding head 24 of FIGS. 2 and 3 includes a heat source downstream of the nozzle 44, such as a laser 46. Exemplary laser heat sources include fiber, diode, CO2, defocused beam, integrated beam, and scanned beam lasers. In the alternate embodiment of FIG. 4, the heat source is an electric arc heating source 66. An electromagnet coil assembly 48 is oriented downstream of the laser 46, which as shown comprises a plurality of lower 50, upper 52, left 54 and right 56 electromagnet coils. When powered by magnetic coil driver 49, the electromagnet coil assembly 48 generates a magnetic field B, which has directional orientation in one or more of the double arrow axes shown in FIG. 2. When energized by the magnetic coil driver 49, the electromagnet coil assembly generates at least an upwardly directed, magnetic field in the Y axis, for levitating the melt stream 16. Optional magnetic field orientation in the Z axis, alone or in combination with the Y axis field, provides a steering force for steering the melt stream 16. Optional magnet field orientation in the X axis direction accelerates or decelerates the melt stream 16 velocity and mass flow rate in the same axial direction. While the electromagnet coils 50, 52, 54 and 56 are shown schematically as flat plate-type coils for generating the magnetic field B, other known coil configurations and structures can be substituted to generate a desired magnetic field. For example, a serial, sequential array of electromagnet coils can be multiplexed to pulse the magnetic field in the X vector direction, in order to accelerate or decelerate the melt stream 16 mass flow rate, or combined with field components in Y and/or Z vector directions, in order to steer the melt stream. Optionally, the magnet coil driver 49 pulses one or more of the electromagnet coils in the coil array 48. Exemplary pulsation methods include time domain pulsing, driving current and/or voltage pulsing, and pulse width modulation. In addition to propulsion gas, in some embodiments, auxiliary inert or partially inert shielding gas is provided enroute to and at the substrate being processed to enable shielding, and prevent atmospheric reaction (especially oxidation) of molten metal.

The welding system 10 includes a controller 60, such as a portable or tablet computer or a programmable logic controller, which is coupled to the powder feed actuator 34 (for issuing feed rate commands F), the valve actuator 40 (for issuing pressure or gas flow rate commands P), the laser 46 (for issuing energy transfer intensity and delivery rate commands E), and the electromagnet coil driver 49 (for varying magnetic field B intensity and/or orientation). The controller 60 is also coupled to the motion control systems, MCST 22 and MCSW 26, for issuing X-Y-Z position commands. In some embodiments, the controller 60 incorporates feedback control loops, for monitoring whether the desired F, P, E, B, and X-Y-Z commands are being performed by the respective devices. In some embodiments, the controller 60 also incorporates diagnostic information such as molten pool temperature and deposit geometry. In an exemplary embodiment, the controller 60 includes a processor and a controller bus in communication therewith. The processor is coupled to one or more internal or external memory devices that include therein operating system and application program software module instruction sets that are accessed and executed by the processor, and cause its respective controlled device (e.g., the powder feed actuator 34, the valve actuator 40, the laser 46), the electromagnet coil driver 49, or the respective motion control systems (MCST 22 and MCSW 26), to perform control operations over their respective associated subsystems.

While reference to an exemplary controller 60 architecture and implementation by software modules executed by the processor, it is also to be understood that the present invention may be implemented in various forms of hardware, software, firmware, special purpose processors, or a combination thereof. Preferably, aspects of the present invention are implemented in software as a program tangibly embodied on a program storage device. The program may be uploaded to, and executed by, a machine comprising any suitable architecture. Preferably, the machine is implemented on a computer platform having hardware such as one or more central processing units (CPU), a random access memory (RAM), and input/output (I/O) interface(s). The controller 60 also includes an operating system and microinstruction code. The various processes and functions described herein may be either part of the microinstruction code or part of the program (or combination thereof) which is executed via the operating system. In addition, various other peripheral devices may be connected to the controller 60.

The controller 60 is optionally in communication with other devices, via a communications bus 62 or by wireless network. It is to be understood that, because some of the constituent system components and method steps depicted in the accompanying figures are preferably implemented in software, the actual connections between the system components (or the process steps) may differ depending upon the manner in which the exemplary embodiments are programmed. Specifically, any of the computer platforms or devices may be interconnected using any existing or later-discovered networking technology and may all be connected through a larger network system, such as a corporate network, metropolitan network or a global network, such as the Internet.

### Welding System Operation

As previously mentioned, in embodiments described herein, one or more of the powder stream mass flow rate, particle melt agglomeration rate and melt stream mass flow rate are selectively controlled and regulated, so that: (i) the melt stream temperature is maintained with sufficient superheat (e.g., 10 to 50 degrees Celsius above melting point of the component material) to enable fusion at the existing superalloy component; and/or (ii) localized melting of the repair or cladding site is no deeper than 10 percent of the void depth or component thickness at the weld site, or in some welding applications localized melting is limited to a depth of one-half millimeter (0.5 mm); and/or (iii) the applied weld cladding layer is continuous, with no pores or voids formed therein. FIGS. 3 and 4 are illustrative of mass transport of and transformation of a powder filler stream 30, to agglomerated molten particles 64, to a continuous melt flow 16 that is directed to a weld site 14 of an existing superalloy component 12. The difference in the embodiments of FIGS. 3 and 4 concerns the heat source for agglomerating molten particles 64; respectively a laser 46 or an electric arc source 66. Other embodiment heat sources include plasma, flame or induction heating.

Pressurized gas at a selected pressure P is introduced into the chamber of the powder spray gun 42, along with filler powder 30 that is discharged at a controlled feed rate F from the outlet of the powder feed 32. A stream of powdered filler 30 is entrained within the pressurized gas and is propelled through the nozzle 44 of the powder spray gun 42, at a powdered stream mass flow rate. After discharge from the nozzle 44, the powdered filler stream 30 is heated by a heat source, such as the laser 46 or the electric arc 66. Heat exposure intensity and transfer rates E are set and monitored by the controller 60, so that the powder particles fuse and agglomerate into molten particles 64 in the region proximate the heat source 46 or 66, and ultimately into a continuous melt stream 16.

The magnetic field strength and orientation B are chosen to counteract downward gravitational pull on the melt stream 16. In a simplified example, the lower and upper levitation coils 50 and 52 provide sufficient levitation power to maintain vertical position of the melt stream 16. In the simplest embodiment, the levitation coil 50 levitates the melt stream 16 to a vertical position that is selectively varied by field strength modulation or by physical movement of the coil to raise or lower application of the weld melt stream onto the repair site 14 on the turbine blade 12. Levitation force is also adjusted to compensate for different material density in melt compositions. Similarly, the left 54 and right 56 deflector coils, alone or cooperation with the upper and lower levitation coils 50, 52 steer or otherwise direct the melt stream to the weld application site. Relative motion between the weld melt stream 16 and the weld site 14 of the superalloy component directs the stream to its intended target area within the weld site 14. The relatively cooler component material at the weld site 14 quenches and solidifies the weld melt stream 16, obviating need for external cooling of the component 12. Melt stream mass flow rate and heat transfer rate to the component substrate are chosen to minimize solidification cracking or subsequent post deposit heat treatment damage to the underlying component. If necessary, multiple weld passes over previously applied, solidified cladding layers are performed to build the weld cladding layer to desired dimensions, whether to fill a void in the component or to increase component dimensional size.

Although various embodiments that incorporate the invention have been shown and described in detail herein, others can readily devise many other varied embodiments that still incorporate the claimed invention. The invention is not limited in its application to the exemplary embodiment details of construction and the arrangement of components set forth in the description or illustrated in the drawings. The invention is capable of other embodiments and of being practiced or of being carried out in various ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted” “connected”, “supported”, and “coupled” and variations thereof are used broadly and encompass direct and indirect mountings, connections, supports, and couplings. Further, “connected” and “coupled” are not restricted to physical, mechanical, or electrical connections or couplings.

What is claimed is:

1. A method for additive weld repair of a void in a repair site of a superalloy component, comprising:
providing a superalloy component, having a repair site, which includes a void having an initial void depth;
propelling a stream of powdered filler, which includes superalloy powder filler, through a nozzle at a powder stream mass flow rate, with pressurized gas;
melting and agglomerating the powdered filler stream into a continuous melt stream, having a melt stream velocity and flow rate, with a laser or arc heating source downstream of the nozzle, while maintaining temperature of the melt stream 10 to 50 degrees Celsius above melting point of the component, to enable fusion at the component repair site;
levitating the melt stream within a magnetic field generated by at least one electromagnet coil that is oriented downstream of the laser or arc heating source;
directing the melt stream into the repair site void, by relative motion between the melt stream and the superalloy component;
the melt stream creating localized melting of the repair site no deeper than ten percent of initial depth of the void.

2. The method of claim 1, further comprising selectively changing velocity or mass flow rate of the melt stream with the at least one electromagnet coil.

3. The method of claim 2, further comprising selectively steering the melt stream velocity direction with the at least one electromagnet coil.

4. The method of claim 1, further comprising enveloping the melt stream in inert or partially inert shielding gas, to prevent atmospheric reaction with molten metal.

5. The method of claim 1, further comprising:
providing an array of electromagnet coils; and
changing speed and/or direction components of the melt stream velocity with the electromagnet coil array.

6. The method of claim 5, further comprising changing speed and/or direction components of the melt stream velocity, by pulsing current flow to the electromagnet coil array.

7. The method of claim 1, further comprising regulating pressurized gas flow rate into the nozzle, for selectively varying mass flow rate of the powdered filler.

8. The method of claim 7, further comprising selectively varying powdered filler mass flow rate, to vary melt temperature and agglomeration rate of the melt stream.

9. The method of claim 1, further comprising:
providing a movable welding head, including the nozzle, heat source, and magnetic coil;
providing a movable workpiece table, for holding the superalloy component;
providing a motion control system coupled to any one or both of the welding head and the workpiece table; and
causing relative motion between the melt stream and the repair site void by moving the workpiece table and/or the welding head, with the motion control system.

10. The method of claim 1, the melt stream creating localized melting of the repair site no deeper than one-half millimeter (0.5 mm).

11. A method for additive weld cladding of a superalloy component, comprising:
providing a superalloy component for cladding, having a cladding site;
propelling a stream of powdered filler, which includes superalloy powder filler, through a nozzle at a powder stream mass flow rate, with pressurized gas;
melting and agglomerating the powdered filler into a continuous melt stream, having a melt stream velocity and flow rate, with a laser or arc heating source downstream of the nozzle, while maintaining temperature of the melt stream 10 to 50 degrees Celsius above melting point of the component, to enable fusion at the component cladding site;
levitating the melt stream within a magnetic field generated by at least one electromagnet coil that is oriented downstream of the laser or arc heating source;
directing the melt stream onto the cladding site, by relative motion between the melt stream and the superalloy component;
the melt stream creating localized melting of the cladding site no deeper than ten percent of component thickness at said site.

12. The method of claim 11, further comprising:
providing an array of electromagnet coils; and
changing speed and/or direction components of the velocity of the melt stream with the electromagnet coil array.

13. The method of claim 12, further comprising:
providing a movable welding head, including the nozzle, heat source, and magnetic coil;
providing a movable workpiece table, for holding the superalloy component;
providing a motion control system coupled to any one or both of the welding head and the workpiece table; and
causing relative motion between the melt stream and the cladding site by moving the workpiece table and/or the welding head, with the motion control system.

14. The method of claim 12, further comprising selectively varying powdered filler mass flow rate, to vary melt temperature and agglomeration rate of the melt stream.

15. A superalloy component additive welding system, comprising:
a workpiece table, for holding a superalloy component that has a cladding site;
a welding head, having:
a pressurized gas source;
a hopper, containing powdered filler that includes superalloy powder filler;
a powder feed in communication with the hopper, including a powder feed outlet;
a nozzle, having an upstream portion in communication with the pressurized gas source and the powder feed outlet, for propelling the powdered filler there through at a powder stream mass flow rate;
a laser or arc heating source downstream of the nozzle, for melting and agglomerating the powdered filler stream into a continuous melt stream, having a melt stream velocity and flow rate, while maintaining temperature of the melt stream 10 to 50 degrees Celsius above melting point of the component, to enable fusion at the component cladding site;
at least one electromagnet coil that is oriented downstream of the laser or arc heating source, for levitating the melt stream with a magnetic field; and
a controller, coupled to the laser or arc heating source and the at least one electromagnet coil for selectively regulating any one or more of melt stream agglomeration, velocity, flow rate, and levitation position relative to the cladding site, so that melt stream temperature is maintained 10 to 50 degrees Celsius above melting point of the component, to enable fusion at the component cladding site, with localized melting of the cladding site no deeper than ten percent of component thickness at said site; and
a source of inert or partially inert shielding gas enveloping the melt stream, to prevent atmospheric reaction with molten metal.

16. The system of claim 15, further comprising an array of electromagnet coils coupled to the controller, the controller changing speed and/or direction components of the velocity of the melt stream with the electromagnet coil array.

17. The system of claim 16, further comprising:
a movable welding head, including the nozzle, heat source, and magnetic coil array;
a movable workpiece table;
a motion control system coupled to the controller and any one or both of the welding head and the workpiece table; and
the motion control system causing relative motion between the melt stream and the cladding site by moving the workpiece table and/or the welding head, in response to movement commands from the controller.

18. The system of claim 15, the controller coupled to the powder feed, for selectively varying powdered filler mass flow rate, to vary melt temperature and agglomeration rate of the melt stream.

19. The system of claim 15, further comprising a pressurized gas regulation valve intermediate and in communication with both the pressurized gas source and the nozzle, coupled to the controller, for selectively varying powdered filler mass flow rate, in response to gas pressure commands from the controller.
